(19) United States
(12) Patent Application Publication
(10) Pub. No.: US 2007/0055947 A1
(43) Pub. Date: Mar. 8, 2007

(54) Animations and transitions

(75) Inventors: Bojana Ostojic, Seattle, WA (US); Christopher A. Glein, Seattle, WA (US); Kort D. Sands, Seattle, WA (US); Mark R. Gibson, Seattle, WA (US); William H. Vong, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/217,490

(22) Filed: Sep. 2, 2005

(51) Int. Cl. G06T 1/00

(52) U.S. Cl. 715/800; 345/418; 715/767

(57) ABSTRACT

Animations and transitions are provided for display of objects in a user interface. The animations and transitions include movement of objects into and within a display area, changes in the size or orientation of an object, and intensity changes for objects within a display area.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Conventional user interfaces provide a two-dimensional display of information for a user. In general, displayed objects appear to occupy the same viewing plane. When two objects occupy the same part of the display, one can typically be selected for full display, but the act of selection conventionally does not provide any additional context for the user.

As computers become more integrated into work and household environments, computer displays will be used from farther distances. For example, computers can be integrated into home media centers, with the computer display used as the video display part of a video system. In such an environment, a user may control a computer using a remote control from a distance of 10 feet away or farther. In such an environment, a flat viewing plane can become difficult to view and interpret.

What is needed is a method for improving how user interfaces and other computer display objects are displayed. The method should be able to assist a user in distinguishing objects on a computer display. Preferably, the method should also provide additional context for the user about the operation of the display or user interface.

### SUMMARY

In various embodiments, animations and transitions are provided for display of objects in a user interface. The animations and transitions include movement of objects into and within a display area, changes in the size or orientation of an object, and intensity changes for objects within a display area. The animations and transitions can be linked to various user actions, such as a change in the selected object or a user request to view a menu of choices.

### BRIEF DESCRIPTION OF THE DRAWINGS

FIG. 1 is block diagram illustrating a computerized environment in which embodiments of the invention may be implemented.

FIG. 2 schematically depicts an example of an image displayed on a display device according to an embodiment of the invention.

### DETAILED DESCRIPTION

### I. Overview

In an embodiment, the invention provides a method for using animations and transitions to add context to user interfaces and other objects displayed on a computer video display. The use of animations and transitions provides the appearance of a three-dimensional viewing display for the user. The use of three-dimensional effects draws a user's eye toward an object of interest without having to hide or eliminate the view of other objects on the display screen. Additionally, using animations and transitions can provide additional context for how to operate the computer. For example, an animation for menu items causing the menu items to enter the screen from one edge of the screen can be used to suggest the availability of additional menu items by scrolling in the entry direction.

### II. Lens Effects

One type of animation that can assist a user is a viewing or magnifying lens over a selected item in the user interface. In an embodiment, a viewing lens can be used in a variety of situations. For example, a viewing lens can be included in a gallery view containing multiple objects, such as a gallery of DVD covers for selecting an available movie for viewing. A viewing lens can also be included as part of a menu listing, or in other types of situations where multiple objects are displayed in a single view.

A viewing lens can be located over a selected object in the gallery, menu list, or other multiple object display. In an embodiment, an object under the viewing lens is enlarged by at least 5%, or at least 10%, or at least 15%, or at least 20% relative to the object size when not selected. Alternatively, an object under the viewing lens can be enlarged by 30% or less, or 25% or less, or 20% or less relative to the object size when not selected. Note that the viewing lens also provides a sharp transition between the enlarged object and any other displayed items.

A new object can be selected by any convenient method. In an embodiment, the selected object is changed by moving the viewing lens to an adjacent object, such as a horizontally adjacent object, a vertically adjacent object, or a diagonally adjacent object. Alternatively, the viewing lens can remain in the same position in the display while a gallery of objects is moved beneath the viewing lens. In still another embodiment, the viewing lens can be moved to any desired location of a displayed image.

Preferably, the movement of the viewing lens to a new selected object or position can be accompanied by one or more animations. The animations can assist a user in understanding which new object has been selected in situations where the user is at a distance from the viewing display. In an embodiment, when a new object is selected, the viewing lens is moved from the previously selected object to the currently selected object. Additional animations can then be used during the time the lens is moving, or the animations can start after the lens is over the new selected object. The previously selected object can shrink back to its original size. The newly selected object can also grow to a larger size.

The change in size of an object can also be combined with a fade effect. During a fade, the displayed intensity of an object is increased or decreased. In an embodiment involving a viewing lens, the additional viewing area occupied by an object can be faded in as the object grows. Thus, instead of a user only seeing a change in size, the display intensity of the growing (or shrinking) edges of an object changes as well.

In another embodiment, grow and fade animations can be used when displaying a menu or other list view of items, such as a gallery of items. In such an embodiment, a menu or list item is selected from the menu or list view. Upon selection, the menu or list item can grow to at least 5%, or at least 10%, or at least 15%, or at least 20%. Alternatively, the menu or list item can grow 30% or less, or 25% or less, or 20% or less. In another embodiment where the menu or list item is a text item, the text item can grow by at least one font size, or at least 2 font sizes, or at least 3 font sizes, or at least 5 font sizes. In yet another embodiment, the menu or list item can grow by 8 font sizes or less, or 6 font sizes or less, or 5 font sizes or less, or 3 font sizes or less.

In an embodiment, the growth of the menu or list item can be accompanied by a fade to show additional information about the selected item. Upon selection of the menu or list item, additional text information about the item can fade in at a designated location in the display area. The additional information can be a title of the selected item, details about the content of the selected item, or any other type of text data. In another embodiment, the fade in of the additional information can be delayed relative to the growth of the menu or list item. For example, the fade in of the additional information can be delayed by at least 0.5 seconds, or at least 1 second, or at least 2 seconds.

In still another embodiment, a selected menu or list item can be animated to shrink and then grow. In such an embodiment, the shrink can cause the menu or list item to be reduced in size by at least 5%, or at least 10%. The menu or list item can then grow to a size greater than its original size, as described above.

### III. Display of Background Images

Another type of animation to assist a user in understanding displayed information is modifying the appearance of images intended to serve as a background. For example, a user can view a movie or other type of video image on a display. Or a user can be viewing a gallery of items for a potential action, such as reviewing the content of one of the gallery items. During viewing of the movie, gallery, or other displayed image, the user may want to work with a menu to perform another action. The action may or may not be related to the current displayed image. In an embodiment, an overlay menu of potential desired actions can be displayed in the same viewing area as the other displayed image. This creates a situation where the overlay menu can be thought of as an image in the foreground, while the movie, gallery, or other displayed image is considered a background image.

To help the user distinguish between the overlay image and the background image, the background image can be tilted away from the user. In an embodiment, this can be accomplished treating the background image as an image lying in a single plane, and pivoting the image around a fixed point or line. For example, one of the corners of the background image could be used as the fixed point. The plane containing the background image can then be rotated by a few degrees around an axis containing the fixed point. Alternatively, an edge of the background image, such as the bottom edge, can be used as a fixed line for rotation. The background image can then be rotated by a few degrees around an axis corresponding to the fixed line.

In an embodiment, the background image can rotated about an axis by at least 2 degrees, or at least 3.5 degrees, or at least 5 degrees. In another embodiment, the background image can be rotated about an axis by 10 degrees or less, or 7.5 degrees or less, or 5 degrees or less. In still another embodiment, after the user finishes manipulating the overlay image, the background image can be restored to its original plane.

In an embodiment, the background image is rotated to appear to tilt away from a user. For example, consider a direction or axis perpendicular to the initial plane of the background image. This direction can be referred to as the Z-axis, and is distinct from the pivot or rotational axis used to tilt the background image. One direction along the axis perpendicular to the image will be toward the user (positive Z), while the other direction will be away from the user (negative Z). When a background image is pivoted or rotated around the rotational axis, the background image can be rotated about in a direction away from the user. A second rotation can then be used to rotate the image toward the user, preferably returning the background image to its original plane.

### IV. Animations for Active Items

Still another type of animation can be used to aid the user in keeping track of currently active items and/or items placed in an execution queue. For example, a user can select a radio station, album, or other music source for playback. After beginning playback, the user can move on to other tasks while the selected music source continues playing. When the next task begins, the majority of the display area can be dedicated to the new task. The music being played represents a background process being run by the user.

An icon representing the background process can be placed in a designated area when a user begins a new task. Preferably, the icon is placed in the designated area using an animation. In an embodiment, the animation begins by having an image containing an icon visible in the display area when a user begins a task that can perform in the background. The icon can be an object in a gallery, a menu item, or any other convenient type of object. When the user starts a new task, the displayed image will change to correspond to the new task. Prior to changing the displayed image, the icon corresponding to the background task can be moved to a designated display area, such as a “Now Playing” area. In an embodiment, the icon is moved across the displayed image to the designated display area. Preferably, the icon is also reduced in size during the move to the designated display area. In an embodiment, the icon or image can be reduced in size by at least 10%, or at least 20%, or at least 30%, or at least 50%. In another embodiment, the icon that is moved and reduced in size corresponds to the initially displayed image.

V. Entry of Items in to Display Area

Still another type of animation is an animation to indicate the presence of more information or choices. In an embodiment, when a list of items is displayed, more items may be available by scrolling, such as by using up and/or down arrows or left and/or right arrows to scroll through a list. The presence of additional choices, as well as the direction to scroll to view the additional choices, can be indicated by moving the list or menu of items in to the display area in a corresponding direction. For example, a menu which can be scrolled up and down can be brought in to the display area from the bottom and moved up, revealing additional parts of the list or menu during the movement.

When an animation is used to indicate the presence of more information or choices, a user can request the additional information or choices using an appropriate action. For example, arrow keys could be used to indicate a desire to scroll objects in the display area in the indicated direction. When the user request is received, additional available objects can become visible at an edge of the display area. Similarly, previously displayed objects can be removed from the display area.

In an embodiment, a list of items can be displayed by consecutively displaying the items at a location at an edge of the display area. As each item appears at the location, the item moves along a direction away from the location. Each item in the display area moves at the same movement rate or speed as each other displayed item, causing the spacing between the items to remain constant as the items move. The items can stop when desired menu locations are reached by the items. In an embodiment, a list can contain more items than are displayed in the display area. These additional items can appear in the display area in response to a scroll request received from the user. Preferably, the scroll request is a request to scroll in a direction corresponding to the movement direction for the initial list of items. As each additional item is displayed, an item can also be removed from the display area.

In another embodiment, an image or icon can be moved in to the display area from the edge of the display area to highlight the presence of another object. For example, an arrow can be moved in to the display area from an edge and positioned next to an image or icon, such as an album cover in a “Now Playing” display area.

In still another embodiment, a list of items can be brought into the display area in a manner to indicate that the list is an overlay that should be viewed as being on top of a background image. For example, a user may want to perform an action using a menu, such as the Start Menu, while performing another task, such as viewing a video. The menu can be brought in as an overlay so that the video remains visible behind the menu.

To assist the viewer in distinguishing between the overlay and the background image, the overlay menu can be brought in to the display area using an animation. In an embodiment, the items in the menu can appear at the bottom of the display area in a first size. As an item appears, it is moved up in the display area while reducing in size. This gives the menu item the appearance of starting out at a height well above the background image and then moving toward the image.

In another embodiment, one or more additional icons can enter the bottom of the display area prior to the first list item being displayed. These one or more additional icons also move up in the display area while reducing in size. After moving up in the display area, the additional icons then move horizontally in the display area. During the horizontal motion, the additional icons retain the same size. This motion by leading icons enhances the appearance that items in the list are descending toward the background image.

In an embodiment, the items entering the display area are reduced in size by at least 5%, or at least 10%, or at least 15%, or at least 20%, or at least 25% as the items move up in the display area. Alternatively, the items are reduced in size by 50% or less, or 40% or less, or 30% or less as the items move up in the display area.

In yet another embodiment, an image or icon can be moved into the display area from an edge of the display area to indicate the presence of additional information that can be obtained by scrolling. For example, an arrow icon can enter the display area from an edge to indicate that another screen of the user interface is available, such as by using a corresponding arrow key, a key such as “Page Up/Page Down”, or by another method for scrolling a view.

VI. General Operating Environment

In another embodiment, there is a multimedia processing system for enabling a user to navigate through media content while still viewing a displayed image in the background. In this embodiment, the multimedia processing system includes multiple components. These components include, but are not limited to, a controller for controlling the multimedia processing system; a processor for providing a multi-dimensional user interface on a display means coupled to the multimedia processing system; a user interface software module for providing a user interface shown on the display means; and a magnifier module for magnifying a selected menu item. This embodiment also enables a user to view, navigate, and select menu items while being able to still view a displayed image in the background. For example, a user could navigate through a details page menu with multiple menu items while viewing a photo being displayed in the background.

According to an embodiment, in order to provide fluidity between the various displays of the user interface based on user inputs, the media user interface may be animated. Because the user of the user interface is typically going to be located farther from the screen than a 2-Foot user interface, it is generally more difficult for a user to see smaller details on the user interface. Instead of instantly changing from one menu to the next, or from one menu item selection to the next, either of which a user might miss if not paying careful attention, animation may be used to illustrate to the user the result of his or her user input, or the changing of one menu to the next, thus making it easier for the user to conceptually follow his or her navigation through the user interface. Furthermore, animation may be used to provide feedback that a user has performed some action on the user interface, such as moving focus from one menu item to another or selecting an entirely new menu item.

In order to provide three-dimensionality and animations, the user interface may be developed using any software package that provides three-dimensionality and graphics acceleration, such as the DirectX® 9.0 software development kit with DirectX 9.0b runtime, available from Microsoft Corporation of Redmond, Wash. The underlying software architecture is secondary to the services it provides the media user interface. Microsoft's DirectX® is a suite of multimedia application programming interfaces (APIs) built into Microsoft's Windows® operating systems, and provides a standard development platform for Windows-based PCs by enabling software developers to access specialized hardware features without having to write hardware-specific code. The APIs act as a bridge for the hardware and the software to communicate. The DirectX® APIs give multimedia applications access to the advanced features of high-performance hardware such as three-dimensional (3-D) graphics acceleration chips and sound cards. The APIs also control low-level functions, including two-dimensional (2-D) graphics acceleration; support for input devices such as joysticks, keyboards, and mice; and control of sound mixing and sound output. Versions of DirectX® prior to versions 9.0 may also or alternatively be used.

Furthermore, according to this embodiment, this system is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

According to another aspect of this embodiment, components of the system may include a system memory, and a system bus that couples various system components including the system memory to the processor. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Additionally, any embodiment may include a variety of computer readable media. Computer readable media can be any available media that can be accessed by the system and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the system. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory may include computer storage media in the form of volatile and/or nonvolatile memory such as read only memory (ROM) and random access memory (RAM). A basic input/output system (BIOS), containing the basic routines that help to transfer information between elements within the system, such as during start-up, is typically stored in ROM. RAM typically contains data and/or program modules that are immediately accessible to and/or presently being operated on by the processor.

The embodiment may also include other removable/non-removable, volatile/nonvolatile computer storage media. For example, a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the illustrative operating environment include, but are not limited to, magnetic tape cassettes, flash memory cards, digital versatile disks, digital video tape, solid state RAM, solid state ROM, and the like. The hard disk drive is typically connected to the system bus through an non-removable memory interface, and magnetic disk drive and optical disk drive are typically connected to the system bus by a removable memory interface.

The drives and their associated computer storage media, discussed above, provide storage of computer readable instructions, data structures, program modules and other data for the system. Additionally, a user may enter commands and information into the system through input devices such as a keyboard and pointing device, commonly referred to as a mouse, trackball or touch pad. Other input devices may include a microphone, joystick, game pad, satellite dish, scanner, or the like. These and other input devices are often connected to the processor through a user input interface that is coupled to the system bus, but may be connected by other interface and bus structures, such as a parallel port, game port or a universal serial bus (USB). A monitor or other type of display means (e.g., a TV) is also connected to the system bus via an interface, such as a video interface. In addition to the monitor, this system may also include other peripheral output devices such as speakers, which may be connected through an output peripheral interface.

In a preferred embodiment, the controller is a remote control device. However, the controller can be any controlling device internal or external to the system. In this embodiment, the processor generates and provides a multi-dimensional user interface using the computer executable software modules stored in the memory cells of the processor. The user interface software module provides animation-enhanced effects to some portions of the user interface. For example, the user interface may include one or more semi-transparent masks for laying over an image.

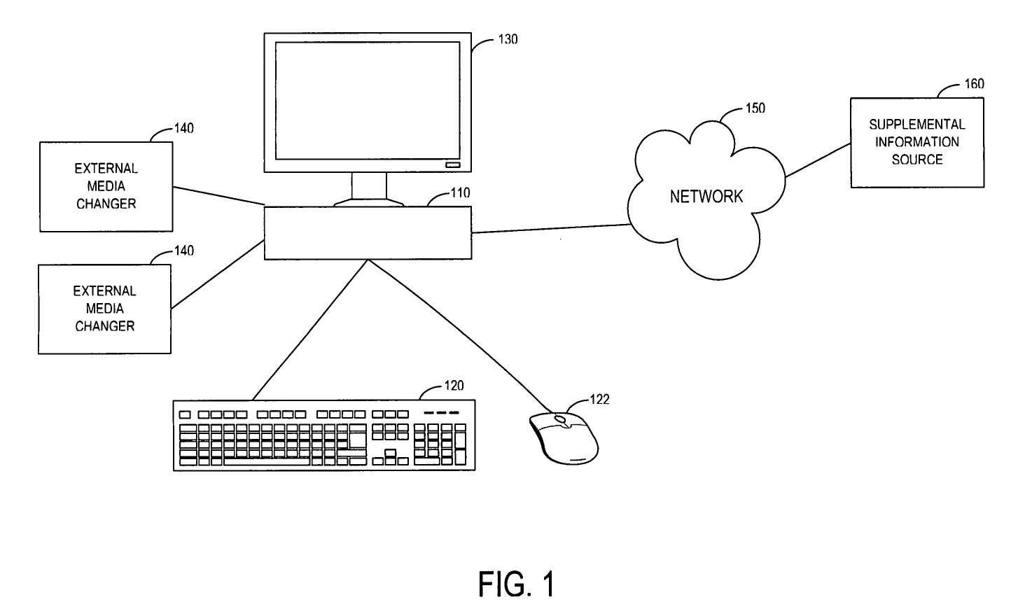

FIG. 1 depicts an example of a system suitable for performing various embodiments of the invention. In FIG. 1, a computer 110 is shown with a variety of available input devices or controllers, including a keyboard 120, a mouse 122, and a remote control 124. Preferably, one or more of these input devices is available for providing input to the computer. The computer 110 is also connected to a monitor or display device 130. The computer 110 can also be connected to one or more external media changers 140. Additionally, computer 110 is connected to a network 150, such as the world-wide web. Via network 150, computer 110 can communicate with one or more external computers 160.

### VI. Exemplary Embodiment

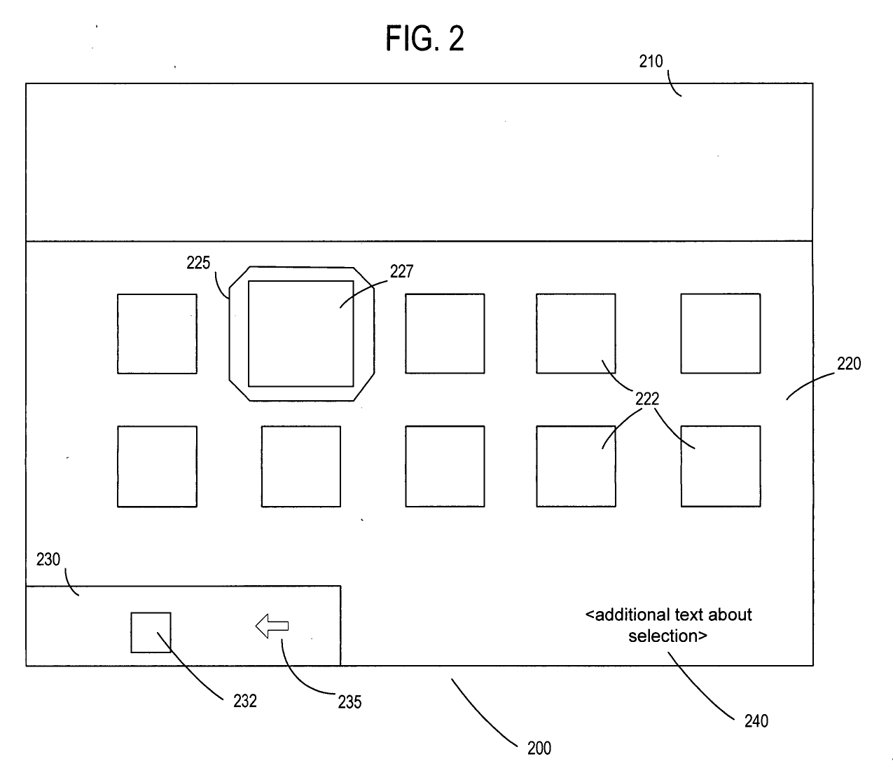

FIG. 2 schematically depicts an example of an image displayed on a display device according to an embodiment of the invention. In FIG. 2, the displayed image 200 is partitioned into several display areas. Pivot region 210 occupies an upper portion of image 200, while gallery 220 occupies a lower portion. Pivot region 210 provides an area for displaying menu choices related to objects 222, 227 in gallery 220. When the pivot region 210 is selected, an animation can be used to tilt gallery 220 by a few degrees around an axis that contains the lower right corner of gallery 220. This animation informs the user that pivot region 210 is currently active.

Magnifying lens or lens effect 225 is located above object 227 in gallery 220. Object 227 is larger than the other objects 222 displayed in the gallery. This lens effect indicates to the user which object in the gallery is currently selected. When a new object is selected, an animation can be used to show the lens moving over the new selected object. Alternatively, the objects in the gallery can be translated to move relative to the lens effect. An animation can also be used to change the sizes of the previous and current object selections. The animations for changing object size can occur simultaneously with the movement of the lens, or the size change can be delayed relative to the motion of the lens. Additionally, after completion of the size change, a text item 240 providing further description about the selected item can appear by fading in to the displayed image.

In an embodiment, objects 222, 227 can represent album covers for CD's that are available for playback. If a user begins playback of a selected CD, an animation can be used to move the selected object to the “Now Playing” area 230 of the image and show the object as a reduced size object 232. An animation can also be used to bring arrow 235 in to the display area from an edge, to highlight the fact that a new item is being played back. The “Now Playing” area 230 and the object 232 can be retained as part of the displayed image even after the user changes to a new task.

In FIG. 2, menu items (not shown) could also be brought in to the displayed image using a variety of animations. In an embodiment, menu items could enter the displayed image from an edge of the image at their final display size. In such an embodiment, the menu items could simply translate in one direction as they enter, in order to indicate the presence of additional items. Alternatively, the menu items could enter at a first, larger size and then shrink as they move in the display image.

The principles and modes of operation of this invention have been described above with reference to various exemplary and preferred embodiments. As understood by those of skill in the art, the overall invention, as defined by the claims, encompasses other preferred embodiments not specifically enumerated herein.

What is claimed is:

1. A method for displaying a plurality of objects, comprising:
selecting an object from a plurality of objects;
increasing the size of the selected object by at least 5%, the increased size being displayed by fading in; and
decreasing the size of at least one other object in the plurality of objects by at least 5%.

2. The method of claim 1, further comprising:
moving a viewing lens over the selected object prior to increasing the size of the selected object.

3. The method of claim 1, further comprising:
delaying at least 0.5 seconds between moving the viewing lens and increasing the size of the second object.

4. The method of claim 1, further comprising:
displaying text related to the second object after moving the viewing lens.

5. The method of claim 1, further comprising:
delaying at least 0.5 seconds between selecting the object and displaying the text related to the selected object.

6. The method of claim 1, further comprising:
reducing the size of the selected object prior to increasing the size, wherein the increase in size is greater than the reduction in size.

7. The method of claim 1, wherein the method is stored as executable instructions on a computer readable medium.

8. A method for displaying a plurality of objects, comprising:
displaying a first image comprising an icon corresponding to a first task in a display area, the display area including a queue region;
receiving a request to perform a second task;
moving the icon corresponding to the first task to the queue region; and
displaying a second image corresponding to the second task in the display area.

9. The method of claim 8, wherein the icon corresponding to the first task is the first image.

10. The method of claim 8, further comprising reducing the size of the icon after receiving the request to perform the second task.

11. The method of claim 10, wherein the size of the icon is reduced prior to moving the icon to the queue region.

12. The method of claim 8, wherein the first image comprises a gallery of icons.

13. The method of claim 8, wherein the method is stored as executable instructions on a computer readable medium.

14. A method for displaying an image, comprising:
displaying a first object at an edge of a display area;
moving the object away from the edge in a movement direction;
receiving a scroll request for a direction corresponding to the movement direction; and
displaying a second object in the display area based on the scroll request.

15. The method of claim 14, further comprising:
displaying at least one additional object at the edge of the display area prior to receiving the scroll request, the at least one additional object moving away from the edge along the same direction as the first object.

16. The method of claim 15, wherein the first object, at least one additional object, and second object comprise a menu or gallery of objects.

17. The method of claim 14, wherein the second object is displayed at the edge of the display area.

18. The method of claim 14, wherein the second object is a full display area image.

19. The method of claim 14, wherein displaying a second object in the display area further comprises removing a third object from the display area.

20. The method of claim 14, wherein the method is stored as executable instructions on a computer readable medium.
